(19) United States
(12) Patent Application Publication
(10) Pub. No.: US 2025/0113317 A1
(43) Pub. Date: Apr. 3, 2025

(54) TIMING ADVANCE REPORTING FORMATS BASED ON CELL TYPE

(71) Applicant: QUALCOMM Incorporated, San Diego, CA (US)

(72) Inventors: Bharat SHRESTHA, San Diego, CA (US); Umesh PHUYAL, San Diego, CA (US); Xiao Feng WANG, San Diego, CA (US)

(21) Appl. No.: 18/791,807

(22) Filed: Aug. 1, 2024

Related U.S. Application Data
(60) Provisional application No. 63/586,284, filed on Sep. 28, 2023.

(51) Int. Cl. H04W 56/00

(52) U.S. Cl. CPC H04W 56/0045; H04W 56/001

(57) ABSTRACT

Methods, systems, and devices for wireless communications are described. A user equipment (UE) may determine that it is communicating with a particular type of cell (e.g., an air to ground (ATG) cell), and may utilize a timing advance (TA) report format corresponding to the determined cell type. The TA report for an ATG cell may use all 16 bits of a TA report to indicate a TA value according to a small time unit. The TA report for an ATG cell may utilize a subset of bits to indicate a symbol-level TA, and the remainder of bits in the TA report may be unused. The TA report for an ATG cell may be a single octet TA report, including reserved bits and a bit that indicates a format for the TA report, and the TA value. The TA report may include reserved bits and the TA value.

### CROSS REFERENCE

The present application for patent claims the benefit of U.S. Provisional Patent Application No. 63/586,284 by SHRESTHA et al., entitled “TIMING ADVANCE REPORTING FORMATS BASED ON CELL TYPE,” filed Sep. 28, 2023, assigned to the assignee hereof, and expressly incorporated by reference herein.

### FIELD OF TECHNOLOGY

The following relates to wireless communications, including timing advance (TA) reporting formats based on cell type.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support timing advance (TA) reporting formats based on cell type. For example, a user equipment (UE) may determine that it is communicating with a particular type of cell (e.g., an air to ground (ATG) cell), and may utilize a TA report format corresponding to the determined cell type. The TA report for an ATG cell may use all 16 bits of a TA report to indicate a TA value according to a small time unit (e.g., a sampling time unit). In some examples, the TA report for an ATG cell may utilize a subset of bits (e.g., 5 bits) to indicate a symbol-level TA, and the remainder of bits in the TA report may go unused (e.g., may be null bits). In some examples, the TA report for an ATG cell may be a single octet TA report. Two bits may be reserved, and a third bit may indicate that the TA report is an ATG cell TA report. The remaining 5 bits may indicate the TA value. Additionally, or alternatively, the TA report may include three reserved bits and a 5-bit TA value (e.g., a logical channel identity (LCID) code point may indicate the ATG cell report format). In some examples, a TA threshold configuration may be indicated via control signaling (e.g., indicating a threshold triggering TA reporting for specific cell types that is symbol based or based on sampling time units).

A method for wireless communications by a user equipment (UE) is described. The method may include receiving information indicative that a cell corresponding to a network entity is an ATG cell, generating, based on the information, a TA report in accordance with a format that corresponds to ATG communications, and transmitting the TA report in accordance with the format.

A UE for wireless communications is described. The UE may include one or more memories storing processor executable code, and one or more processors coupled with the one or more memories. The one or more processors may individually or collectively operable to execute the code to cause the UE to receive information indicative that a cell corresponding to a network entity is an ATG cell, generate, based on the information, a TA report in accordance with a format that corresponds to ATG communications, and transmit the TA report in accordance with the format.

Another UE for wireless communications is described. The UE may include means for receiving information indicative that a cell corresponding to a network entity is an ATG cell, means for generating, based on the information, a TA report in accordance with a format that corresponds to ATG communications, and means for transmitting the TA report in accordance with the format.

A non-transitory computer-readable medium storing code for wireless communications is described. The code may include instructions executable by a processor to receive information indicative that a cell corresponding to a network entity is an ATG cell, generate, based on the information, a TA report in accordance with a format that corresponds to ATG communications, and transmit the TA report in accordance with the format.

In some examples of the method, UEs, and non-transitory computer-readable medium described herein, generating the TA report may include operations, features, means, or instructions for generating a TA value indicated by two octets of bits in the TA report, each code point of the two octets of the TA report corresponding to a respective sampling time unit of a set of multiple candidate sampling time units.

In some examples of the method, UEs, and non-transitory computer-readable medium described herein, a reserved LCID code point includes an indication that the format corresponds to a granularity of sampling time units.

In some examples of the method, UEs, and non-transitory computer-readable medium described herein, receiving the information may include operations, features, means, or instructions for receiving an indication that the cell supports the format corresponding to the ATG cell.

In some examples of the method, UEs, and non-transitory computer-readable medium described herein, generating the TA report may include operations, features, means, or instructions for generating a TA value indicated by a first subset of bits of a set of multiple bits of the TA report, each code point of the first subset of bits corresponding to a respective quantity of symbols, where a second portion of bits of the set of multiple bits may be null bits.

In some examples of the method, UEs, and non-transitory computer-readable medium described herein, a symbol duration corresponding to the TA value may be based on a subcarrier spacing that the UE may be configured with during generation of the TA value.

In some examples of the method, UEs, and non-transitory computer-readable medium described herein, generating the TA report may include operations, features, means, or instructions for setting a first bit of a set of multiple bits of the TA report to indicate the format corresponding to the TA report, generating a TA value indicated by a subset of bits of the set of multiple bits of the TA report, each code point of the subset of bits indicating a respective quantity of symbols, and setting one or more reserved bits to zero.

In some examples of the method, UEs, and non-transitory computer-readable medium described herein, the one or more reserved bits, the first bit, and the subset of bits, include a single octet of the TA report and a symbol duration corresponding to the TA value may be based on a subcarrier spacing that the UE may be configured with during generation of the TA value.

In some examples of the method, UEs, and non-transitory computer-readable medium described herein, generating the TA report may include operations, features, means, or instructions for generating a TA value indicated by a subset of bits of a set of multiple bits of the TA report, each code point of the subset of bits indicating a respective quantity of symbols and setting one or more reserved bits to zero.

In some examples of the method, UEs, and non-transitory computer-readable medium described herein, the one or more reserved bits, and the subset of bits, include a single octet of the TA report and a symbol duration corresponding to the TA value may be based on a subcarrier spacing that the UE may be configured with during generation of the TA value.

In some examples of the method, UEs, and non-transitory computer-readable medium described herein, the one or more reserved bits, one or more bits indicating a subcarrier spacing, and the subset of bits, include a single octet of the TA report and a symbol duration corresponding to the TA value may be based on the subcarrier spacing during generation of the TA value.

Some examples of the method, UEs, and non-transitory computer-readable medium described herein may further include operations, features, means, or instructions for receiving control signaling indicating a threshold timing offset triggering transmission of the TA report, where transmitting the TA report may be based on determining that a transmission timing value satisfies the threshold timing offset.

In some examples of the method, UEs, and non-transitory computer-readable medium described herein, the threshold timing offset includes a quantity of symbols, or a quantity of sampling time units.

A method for wireless communications by a network entity is described. The method may include transmitting information indicative that a cell corresponding to the network entity is an ATG cell, receiving, from a UE and responsive to transmission of the information, a TA report in accordance with a format that corresponds to ATG communications, and communicating with the UE in accordance with the TA report.

A network entity for wireless communications is described. The network entity may include one or more memories storing processor executable code, and one or more processors coupled with the one or more memories. The one or more processors may individually or collectively operable to execute the code to cause the network entity to transmit information indicative that a cell corresponding to the network entity is an ATG cell, receive, from a UE and responsive to transmission of the information, a TA report in accordance with a format that corresponds to ATG communications, and communicate with the UE in accordance with the TA report.

Another network entity for wireless communications is described. The network entity may include means for transmitting information indicative that a cell corresponding to the network entity is an ATG cell, means for receiving, from a UE and responsive to transmission of the information, a TA report in accordance with a format that corresponds to ATG communications, and means for communicating with the UE in accordance with the TA report.

A non-transitory computer-readable medium storing code for wireless communications is described. The code may include instructions executable by a processor to transmit information indicative that a cell corresponding to the network entity is an ATG cell, receive, from a UE and responsive to transmission of the information, a TA report in accordance with a format that corresponds to ATG communications, and communicate with the UE in accordance with the TA report.

In some examples of the method, network entities, and non-transitory computer-readable medium described herein, the TA report may include operations, features, means, or instructions for a TA value indicated by two octets of bits in the TA report, each code point of the two octets of the TA report corresponding to a respective sampling time unit of a set of multiple candidate sampling time units.

In some examples of the method, network entities, and non-transitory computer-readable medium described herein, a reserved LCID code point includes an indication that the format corresponds to a granularity of sampling time units.

In some examples of the method, network entities, and non-transitory computer-readable medium described herein, transmitting the information may include operations, features, means, or instructions for transmitting an indication that the cell supports the format corresponding to the ATG cell.

In some examples of the method, network entities, and non-transitory computer-readable medium described herein, the TA report may include operations, features, means, or instructions for a TA value indicated by a first subset of bits of a set of multiple bits of the TA report, each code point of the first subset of bits corresponding to a respective quantity of symbols, where a second portion of bits of the set of multiple bits may be null bits.

In some examples of the method, network entities, and non-transitory computer-readable medium described herein, a symbol duration corresponding to the TA value may be based on a subcarrier spacing with which the UE may be configured.

In some examples of the method, network entities, and non-transitory computer-readable medium described herein, the TA report may include operations, features, means, or instructions for a first bit of a set of multiple bits indicating the format corresponding to the TA report, a TA value indicated by a subset of bits of the set of multiple bits of the TA report, each code point of the subset of bits indicating a respective quantity of symbols, and one or more reserved bits.

In some examples of the method, network entities, and non-transitory computer-readable medium described herein, the one or more reserved bits, the first bit, and the subset of bits, include a single octet of the TA report, and a symbol duration corresponding to the TA value may be based on a subcarrier spacing with which the UE may be configured.

In some examples of the method, network entities, and non-transitory computer-readable medium described herein, the TA report may include operations, features, means, or instructions for a TA value indicated by a subset of bits of a set of multiple bits of the TA report, each code point of the subset of bits indicating a respective quantity of symbols, and one or more reserved bits.

In some examples of the method, network entities, and non-transitory computer-readable medium described herein, the one or more reserved bits, and the subset of bits, include a single octet of the TA report, and a symbol duration corresponding to the TA value may be based on a subcarrier spacing with which the UE may be configured.

In some examples of the method, network entities, and non-transitory computer-readable medium described herein, the one or more reserved bits, one or more bits indicating a subcarrier spacing, and the subset of bits, include a single octet of the TA report, a symbol duration corresponding to the TA value may be based on a subcarrier spacing with which the UE may be configured.

Some examples of the method, network entities, and non-transitory computer-readable medium described herein may further include operations, features, means, or instructions for transmitting control signaling indicating a threshold timing offset triggering transmission of the TA report, where receiving the TA report may be based on a transmission timing value satisfying the threshold timing offset.

In some examples of the method, network entities, and non-transitory computer-readable medium described herein, the threshold timing offset includes a quantity of symbols, or a quantity of sampling time units.

### BRIEF DESCRIPTION OF THE DRAWINGS

FIG. 1 shows an example of a wireless communications system that supports timing advance (TA) reporting formats based on cell type in accordance with one or more aspects of the present disclosure.

FIG. 2 shows an example of a wireless communications system that supports TA reporting formats based on cell type in accordance with one or more aspects of the present disclosure.

FIG. 3 shows an example of a TA reporting scheme that supports TA reporting formats based on cell type in accordance with one or more aspects of the present disclosure.

FIG. 4 shows an example of a TA reporting scheme that supports TA reporting formats based on cell type in accordance with one or more aspects of the present disclosure.

FIG. 5 shows an example of a TA reporting scheme that supports TA reporting formats based on cell type in accordance with one or more aspects of the present disclosure.

FIG. 6 shows an example of a TA reporting scheme that supports TA reporting formats based on cell type in accordance with one or more aspects of the present disclosure.

FIG. 7 shows an example of a process flow that supports TA reporting formats based on cell type in accordance with one or more aspects of the present disclosure.

FIGS. 8 and 9 show block diagrams of devices that support TA reporting formats based on cell type in accordance with one or more aspects of the present disclosure.

FIG. 10 shows a block diagram of a communications manager that supports TA reporting formats based on cell type in accordance with one or more aspects of the present disclosure.

FIG. 11 shows a diagram of a system including a device that supports TA reporting formats based on cell type in accordance with one or more aspects of the present disclosure.

FIGS. 12 and 13 show block diagrams of devices that support TA reporting formats based on cell type in accordance with one or more aspects of the present disclosure.

FIG. 14 shows a block diagram of a communications manager that supports TA reporting formats based on cell type in accordance with one or more aspects of the present disclosure.

FIG. 15 shows a diagram of a system including a device that supports TA reporting formats based on cell type in accordance with one or more aspects of the present disclosure.

FIGS. 16 through 19 show flowcharts illustrating methods that support TA reporting formats based on cell type in accordance with one or more aspects of the present disclosure.

### DETAILED DESCRIPTION

A user equipment (UE) (e.g., an airborne UE, such as an airplane) may travel at high altitude and at a high rate of speed. This may result in a round trip time (RTT) of signaling between the UE and a ground-based network entity to change quickly. A quickly changing Doppler effect may also be observed for wireless transmissions between the UE and one or more network entities. For at least these reasons, an airborne UE may benefit from transmitting a timing advance (TA) report, which may indicate a TA value. The TA value may be used to offset timing issues to align wireless communications. However, some wireless communications techniques (e.g., for some types of cell) may support a TA report including two octets, capable of indicating TA values at a slot-level granularity. An airborne UE, such as an airplane, may be capable of reporting TA values at a different granularity (e.g., timing issues may occur for an airborne UE at a different granularity than for other ground-based UEs).

For example, a TA report for some cells may include a 16 bit media access control (MAC) control element (CE) including two octets (e.g., two reserved bits, and 14 bits for indicating slot-level TA values). Some cells (e.g., air to ground (ATG) cells) may support symbol-level TA reporting, which may be accomplished with fewer bits than the 14 bits available in some TA report formats. In such examples, a TA report may either fail to utilize the increased granularity available in a two-octet TA report, or may effectively use fewer bits for symbol-level TA reporting, in which case the remaining available bits may be unutilized, resulting in increased signaling overhead, increased processing at the UE, increased delays, and inefficient use of available computational resources and system resources.

According to techniques described herein, a UE may determine that it is communicating with a particular type of cell (e.g., an ATG cell). Based on the determined cell type, the UE may utilize a TA report format corresponding to the determined cell type. For example, the TA report for an ATG cell may use all 16 bits of the TA report (e.g., up to 57,344 values) to indicate a TA value according to a small time unit (e.g., a sampling time unit). In some examples, the TA report for an ATG cell may utilize a subset of bits (e.g., 5 bits) to indicate a symbol-level TA, and the remainder of bits in the TA report may go unused (e.g., may be null bits). In some examples, the TA report for an ATG cell may be a single octet TA report. Two bits may be reserved, and a third bit may indicate that the TA report is an ATG cell TA report. The remaining 5 bits may indicate the TA value. Additionally, or alternatively, the TA report may include three reserved bits and a 5-bit TA value (e.g., a logical channel identity (LCID) code point may indicate the ATG cell report format). In some examples, a TA threshold configuration may be indicated via control signaling (e.g., indicating a threshold triggering TA reporting for specific cell types that is symbol based or based on sampling time units).

Aspects of the disclosure are initially described in the context of wireless communications systems. Aspects of the disclosure are further illustrated by and described with reference to wireless communications systems, TA reporting schemes, and process flows. Aspects of the disclosure are further illustrated by and described with reference to apparatus diagrams, system diagrams, and flowcharts that relate to TA reporting formats based on cell type.

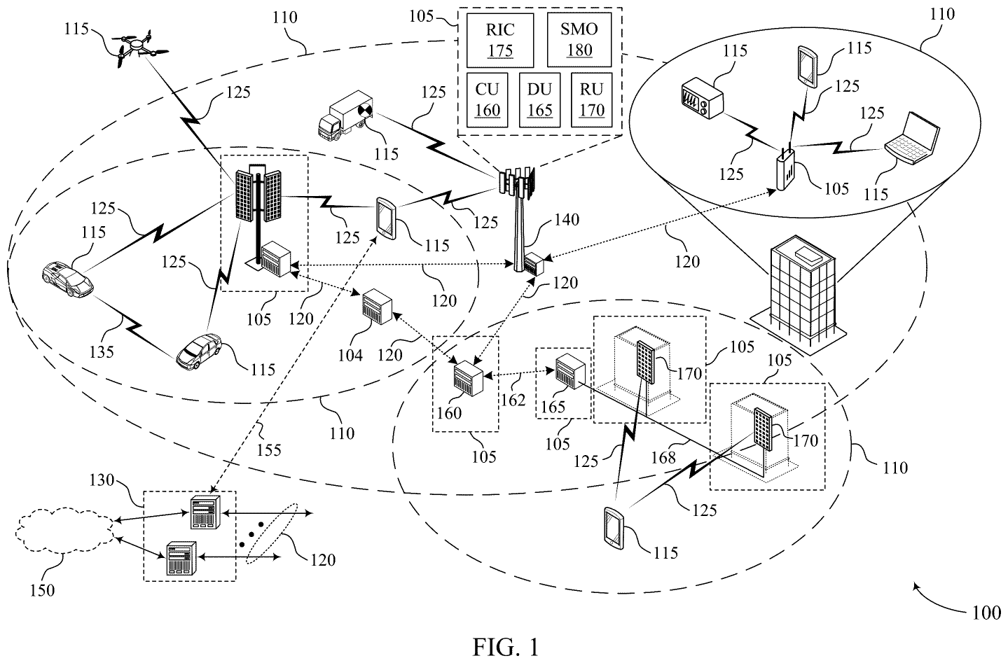

FIG. 1 shows an example of a wireless communications system 100 that supports TA reporting formats based on cell type in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160.

Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support TA reporting formats based on cell type as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

According to techniques described herein, a UE 115 may determine that it is communicating with a particular type of cell (e.g., an ATG cell). Based on the determined cell type, the UE may utilize a TA report format corresponding to the determined cell type. For example, the TA report for an ATG cell may use all 16 bits of the TA report (e.g., up to 57,344 values) to indicate a TA value according to a small time unit (e.g., a sampling time unit). In some examples, the TA report for an ATG cell may utilize a subset of bits (e.g., 5 bits) to indicate a symbol-level TA, and the remainder of bits in the TA report may go unused (e.g., may be null bits). In some examples, the TA report for an ATG cell may be a single octet TA report. Two bits may be reserved, and a third bit may indicate that the TA report is an ATG cell TA report. The remaining 5 bits may indicate the TA value. Additionally, or alternatively, the TA report may include three reserved bits and a 5-bit TA value. In some examples, a TA threshold configuration may be indicated via control signaling (e.g., indicating a threshold triggering TA reporting for specific cell types that is symbol based or based on sampling time units).

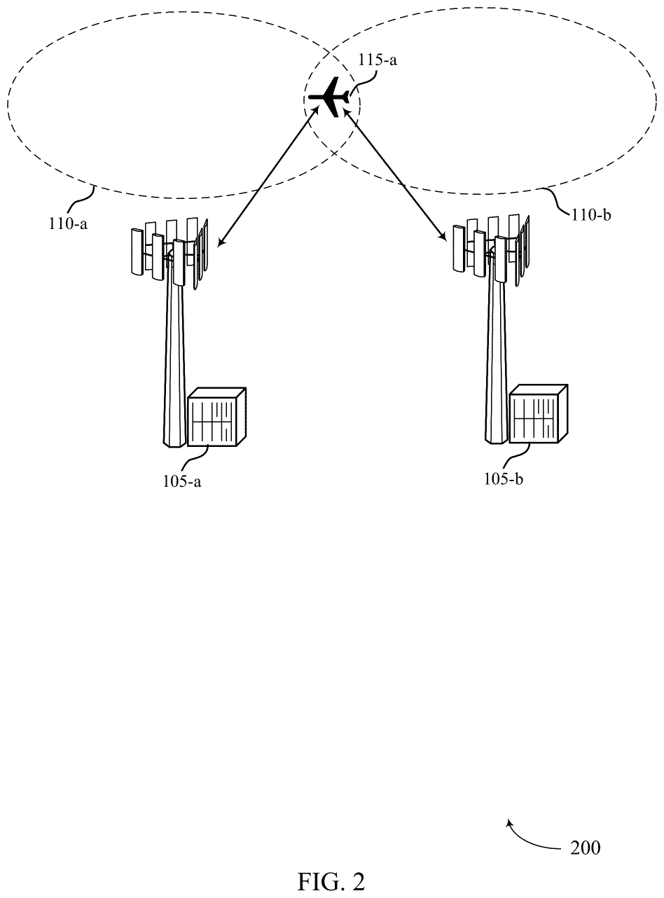

FIG. 2 shows an example of a wireless communications system 200 that supports TA reporting formats based on cell type in accordance with one or more aspects of the present disclosure. The wireless communications system 200 may implement, or be implemented by, aspects of the wireless communications system 100. For example, the wireless communications system 200 may include a UE 115-a, and one or more network entities 105 (e.g., the network entity 105-a and the network entity 105-b), which may be examples of corresponding devices described with reference to FIG. 1.

In some examples, the wireless communications system 200 may support communications between network entities 105 and one or more UEs 115. In some examples, a UE 115-a may be a mobile UE, moving at high rates of speed. For instance, the UE 115-a may be an airborne UE, such as an airplane (e.g., or a device aboard or attached to the airplane). For example, the UE 115-a may operate at a high altitude (e.g., around 10 kilometers (kms). In some examples, the network entities 105 may communicate with airborne UEs 115. For instance, the network entity 105-a may be an ATG network entity (e.g., an ATG gNB or ATG eNB, among other examples), and the network entity 105-b may be an ATG network entity. In such examples, the network entity 105-a may support communications in a first cell (e.g., via a first coverage area 110-a) and the network entity 105-b many support communications in second cell (e.g., via a second coverage area 110-b). The network entities 105 may support wireless communications within respective cell ranges (e.g., 200 to 300 kms).

In some examples, ATG communicates may rely on frequency pre-compensation due to Doppler effects (e.g., due to the high mobility, speed, and altitude of the UE 115-a). The UE 115-a may be GNSS capable, and may have access to the location of ATG network entities 105. In some examples, the UE 115-a may receive (e.g., via a network entity 105) control signaling indicating ATG cell information. For instance, system information (e.g., a system information block (SIB)) may indicate ATG network entity reference location (e.g., for the network entity 105-a and the coverage area 110-a), cell specific information, such as an offset value (K offset) for timing and communications, among other examples. Such control signaling may also include broadcast information such as neighbor cell reference locations (e.g., for the network entity 105-b and the coverage area 110-b).

Some cells (e.g., ATG cells) may support time division duplex (TDD) operations. The network may rely on information regarding latest or most recent TA information at the UE 115-a, to efficiently schedule uplink and downlink subframes. A UE may therefore transmit a TA report indicating a TA value to the network entity of a given cell (e.g., the network entity 105-a or the network entity 105-b). Such TA values may be utilized by the network to mitigate the Doppler effect of the highly mobile UE 115-a. In some examples, the wireless communications system 200 may support optional TA reporting for ATG UEs 115 (e.g., the UE 115-a) based on mechanisms (e.g., as described herein) to assist the network in reducing guard period (GP) overhead for TDD systems. The coverage range of the ATG cell may be up to 300 kms.

Different types of cells may support different granularities of TA values. For example, some wireless communications systems (e.g., non-terrestrial network (NTN) systems) may support a TA reporting at a first granularity. In such examples, a TA reporting trigger may be configured at a UE 115, and TA reporting may be based on a 1 ms slot length. Such a TA report may include two bytes of a fixed MAC-CE length, and the MAC-CE may include 16 bits (e.g., two octets), with two reserved bits and 14 bits available for the TA value of the TA report. The TA reporting format for some cells (e.g., an NTN cell) may indicate at least an integer number of slots, according to a subcarrier spacing (e.g., 15 kHz), where the integer number of slots is greater than or equal to the TA value.

However, some cells may support TA values of a different granularity. For instance, an ATG cell support a different threshold (e.g., timing offset) for TA reporting, and a TA value for an ATG cell may be defined in terms of symbols (e.g., not slots). TA reporting for ATG cells may be done according to a symbol-level granularity (e.g., for a coverage range of up to 300 kms). Symbol duration may be based on SCS (e.g., 15 kHz, or 30 kHz). A TA value for an ATG cell may be between 1 and 29 symbols, in some examples.

The UE 115-a may support TA reporting for one cell type (e.g., NTN cells). However, reporting TA values at a symbol-level of granularity (e.g., instead of a slot-level) may not utilize the same quantity of bits. That is, while 14 bits of a two-octet MAC-CE may be utilized to indicate a slot based TA value (e.g., for an NTN cell), less bits may be used to effectively indicate a symbol based TA value (e.g., for ATG cells). In some examples, reporting ATG TA values using another TA report format may result in inefficiently transmitting large TA reports (e.g., with only a small quantity of bits needed for the TA value), increased signaling overhead, decreased throughout, increased delays, and increased system latency. Additionally, use of another TA format, without a mechanism for identifying the other TA format by the receiving network entity 105, may result in failed communications, timing issues, and further increased system latency, among other examples.

Techniques described herein describe mechanisms for TA reporting using TA report formats that may be cell specific. For example, the UE 115-a may use a first TA report format for communicating with a first type of cell (e.g., an NTN cell), and a second TA report format for communicating with a second type of cell (e.g., an ATG cell). Techniques described herein may also support rules or procedures for interpreting such TA report formats by the network entity 105 (e.g., techniques for indicating or determining when a TA report is an ATG TA report or another type of TA report). Although in some cases described and illustrated with reference to an ATG cell, techniques described herein may apply to various types of cells (e.g., different TA report formats for different types of cells may include ATG cells, NTN cells, cells for airborne UEs 115, high mobility cells, or the like).

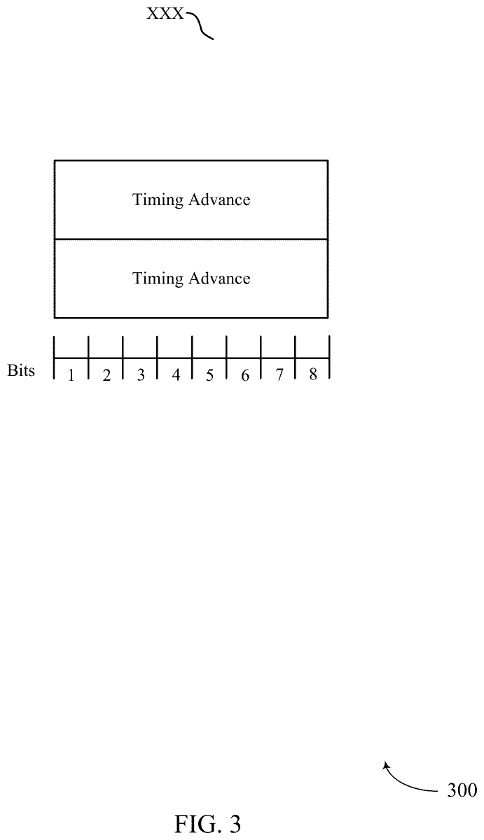

FIG. 3 shows an example of a TA reporting scheme 300 that supports TA reporting formats based on cell type in accordance with one or more aspects of the present disclosure. TA reporting scheme 300 may implement, or be implemented by, aspects of the wireless communications system 100 and the wireless communications system 200. For example, a UE (e.g., such as the UE 115-a) and one or more network entities (e.g., network entities 105, such as the network entity 105-a and the network entity 105-b) may communicate with each other according to the TA reporting scheme 300.

In some examples, a UE connected to a particular cell type (e.g., an ATG cell) may report TA values with a TA granularity of 1 symbol, and a range of 1 symbol to 28 symbols. Such a TA reporting granularity may correspond to one or more SCSs (e.g., 15 kHz and 30 kHz). A symbol duration may depend on the SCS (e.g., a symbol duration of 66.67 us for a SCS of 15 kHz, and a symbol duration of 33.33 us for an SCS of 30 kHz). However, as described herein, a TA value of 1 to 28 symbols may be indicated using less bits than are available in a TA report message. For instance, a TA report message for a slot based TA value may include two octets (e.g., 16 bits). One or more (e.g., two) bits may be reserved bits, and one or more bits (e.g., 14 bits) may be utilized to indicate the TA value. However, the UE (e.g., the UE 115-a connected to an ATG cell) may be able to use less bits to indicate a symbol-level TA value (e.g., 5 bits).

In some examples, to effectively utilize the available bits of a TA report, the UE may report an exact TA value (e.g., instead of reporting an integer value of a quantity of symbols greater than the exact TA value). Exact TA value reporting may utilize a higher quantity of bits, and may be more specific and exact than symbol-level TA reporting. AN exact TA value calculation may be a fraction of a time interval (e.g., a fraction of a symbol), and may be referred to as a smallest unit of time T_{c} (e.g., T_{c}=0.509 ns) or a sampling time unit Tₛ ((e.g., Tₛ=32.552 ns). For example, the smallest unit of time T_{c} may be defined as T_{c}=1/(Δfₘₐₓ·N_{f}) where Δfₘₐₓ=40·103 Hz and where ·N_{f}=1=4096. The Sampling time unit Tₛ may be defined where Tₛ=1/(Δf_{ref}·N_{f,ref}), where Δf_{ref}=15·10³ Hz, and where N_{f,ref}=2048.

The TA reporting granularity may be defined (e.g., in one or more standards documents) according to a format that can support any SCS (e.g., in terms of a smallest unit of time). For instance, such a TA reporting granularity may be applicable to SCS of 60 kHz, among other examples. For an SCS of 15 kHz, to report for a threshold quantity of 28 symbols, a threshold quantity of code points may be defined as 28×Nf, ref=28×2048=57,334. 16 code points may therefore be utilized to indicate an exact TA value using a small time increment (e.g., T_{c} or Tₛ).

In some examples, the UE may access an ATG cell, and may transmit a TA report that indicates an exact TA value (e.g., or nearly exact TA value). In such examples, for the ATG cell, the TA report may use a full two-octet bitstring indicating the TA value (e.g., each code point of the 16 bits indicating one of the 57, 344 values). Each candidate TA value (e.g., each code point of the 16 bit TA value) may indicate a small time unit, such as a sampling time unit Tₛ.

In some examples, the TA report format used by the UE may depend on the type of cell with which the UE is communicating. For a first type of cell (e.g., an NTN cell), the UE may transmit a TA report according to a first TA report format, which may include a MAC-CE including 16 bits, one or two reserved bits and 14 bits for a slot-based TA value. Such a TA report format may include a TA field (e.g., for the TA value) indicating a least integer quantity of slots, using a particular SCS (e.g., 15 kHz) greater than or equal to an exact TA value. For a second type of cell (e.g., an ATG cell), the UE may transmit a TA report according to a second TA report format (e.g., a MAC-CE including 16 bits, all 16 bit indicating a TA value according to a Tₛ granularity). Such a TA report format for the ATG cell may be defined in one or more standards documents, or configured at the UE by the network. In the ATG cell, the TA field indicating the TA value may indicate a quantity of small time units (e.g., a sampling time unit Tₛ), and the length of the TA field may be 16 bits. The UE may determine which TA report format to use based on a type of cell (e.g., may receive, from the network entity, information indicative of the cell type, such as a cell identifier, list of neighbor cells, cell location, coverage area, among other examples).

The network entity receiving the TA report may determine a type of TA report and therefore successfully decode and read the TA report. In some examples, the type of TA report may be implicit (e.g., if the network entity supports an ATG cell, then the network entity may expect to receive TA reports according to the ATG TA report format). In some examples, the UE may transmit an explicit indication of the type of TA report. For example, a reserved LCID code point may be used to indicate a TA format type (e.g., an LCID code point may indicate that the TA report corresponds to the TA format for an ATG cell, including a 16-bit TA report indicating an exact TA value according to a sampling time unit or a smallest time unit).

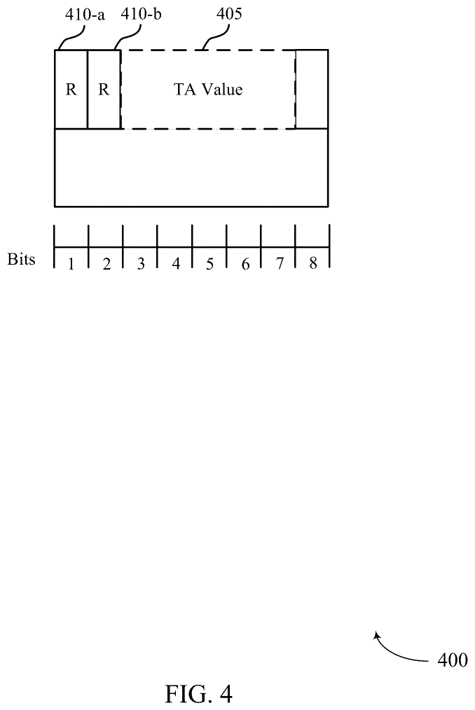

FIG. 4 shows an example of a TA reporting scheme 400 that supports TA reporting formats based on cell type in accordance with one or more aspects of the present disclosure. TA reporting scheme 400 may implement, or be implemented by, aspects of the wireless communications system 100, the wireless communications system 200, and the TA reporting scheme 300. For example, a UE (e.g., such as the UE 115-a) and one or more network entities (e.g., network entities 105, such as the network entity 105-a and the network entity 105-b), which may be examples of corresponding devices described with reference to FIGS. 1-3, may communicate with each other according to the TA reporting scheme 400.

In some examples, the UE may transmit a TA report including a TA value 405 that utilizes only the bits needed for indicating a quantity of symbols (e.g., 1-28 symbols). For example, the UE may utilize 5 bits of the available bits of TA report to indicate the symbol-level TA value 405. If the TA report includes one or more reserved bits 410 (e.g., the reserved bit 410-a and the reserved bit 410-b, both set to 0), then a remainder of the bits of the TA report may be ignored. For instance, 14 bits of the TA report may be used (e.g., without changing a size of the report for different types of cells), only values from 1 to 28 are indicated by code points of the TA value 405, and the rest of the available values (e.g., all other code points of the TA field) are ignored. In some examples, only 5 bits of the TA report may be used for the TA value 405, and the remainder of the bits (e.g., 9 bits) may be ignored.

In some examples, the use of the TA report (e.g., which code point are available for the TA value 405) may depend on a cell type with which the UE communicates. For example, for some cell types (e.g., NTN cell types) and in some frequency bands (e.g., FR 1), the TA field may indicate the least integer quantity of slots, using a SCS (e.g., 15 kHz) greater than or equal to the TA value 405. In cases of ATG access, the TA field may indicate a least integer quantity of symbols greater than or equal to the TA value 405. The symbol duration may be based on the SCS the UE is currently configured with (e.g., via control signaling indicating the SCS for the UE). In some examples, the SCS may be 15 kHz, or 30 kHz, in which case the UE may indicate a value of 1 through 28 for the TA value 405 in the ATG cell. In some examples, the UE may determine which TA report format to use based on a type of cell (e.g., may receive, from the network entity, information indicative of the cell type, such as a cell identifier, list of neighbor cells, cell location, coverage area, among other examples).

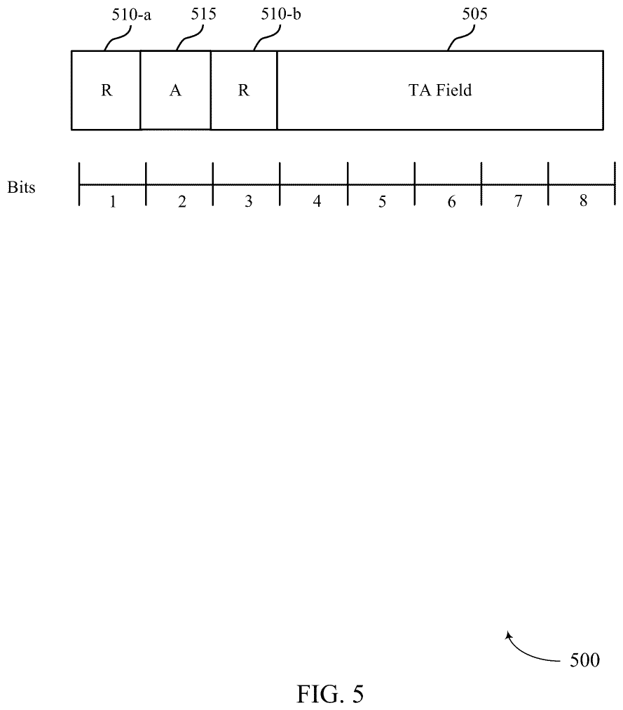

FIG. 5 shows an example of a TA reporting scheme 500 that supports TA reporting formats based on cell type in accordance with one or more aspects of the present disclosure. TA reporting scheme 500 may implement, or be implemented by, aspects of the wireless communications system 100, the wireless communications system 200, the TA reporting scheme 300, or the TA reporting scheme 400. For example, a UE (e.g., such as the UE 115-a) and one or more network entities (e.g., network entities 105, such as the network entity 105-a and the network entity 105-b), which may be examples of corresponding devices described with reference to FIGS. 1-4, may communicate with each other according to the TA reporting scheme 500.

In some examples, the UE may transmit a TA report that is smaller for some types of cells, and larger for other types of cells. For example, for an ATG cell, the UE may use one or more bits (e.g., 5 bits) to indicate the TA value. The TA report may include one or more reserved bits 510 (e.g., the reserved bit 510-a and the reserved bit 510-b). One or more bits, such as the bit 515 (e.g., another reserved bit or a specifically designated bit) may be utilized to indicate the TA format of the TA report (e.g., a TA format that will indicate the TA value in units of a quantity of symbols). Such a TA report may include a fixed size of a MAC-CE (e.g., 1 octet). The TA report may include one or more reserved bits 510 (e.g., set to 0). The bit 515 may indicate the type of TA report format. For example, in a first type of cell (e.g., an NTN cell), the bit 515 may set to 0 (e.g., in which case the TA report may include a MAC-CE size of two octets). In a second type of cell (e.g., an ATG cell), the bit 515 may be set to a value of 1. When the bit 515 is set to 1, the TA report MAC-CE may have a fixed size of one octet.

In a first type of cell (e.g., an NTN cell) and in some frequency bands (e.g., FR 1), when the bit 515 is set to 0, the TA field 505 may indicate the least integer quantity of slots, using a SCS (e.g., of 15 kHz) greater than or equal to the TA value. The length of the TA field 505 if the bit 515 is set to 0 may be large (e.g., 14 bits). In some frequency bands (e.g., FR 1) when the bit 515 is set to 1, the TA field 505 may indicate the least integer quantity of symbols greater than or equal to the TA value. The symbol duration may be based on the SCS with which the UE is currently configured (e.g., which may be 15 kHz, or 30 kHz, in some examples). The length of the TA field when the bit 515 is set to 1 may be small (e.g., 5 bits). Techniques described with reference to FIG. 5 may similarly be applicable for different bit values (e.g., for the bit 515, where 0 or 1 may be defined to indicate either the ATG cell, or another type of cell), or for different sizes of indicators (e.g., a larger quantity of bits, such as one or more reserved bits 510, may be used to indicate various types of cells and TA report formats).

In some examples, such a TA report format may be used in any cell if the cell supports such a TA report. In some examples, the cell (e.g., the network entity corresponding to the cell) may transmit control signaling indicating that the network entity supports the TA report format of the TA reporting scheme 500, based on which the UE may transmit such a TA report.

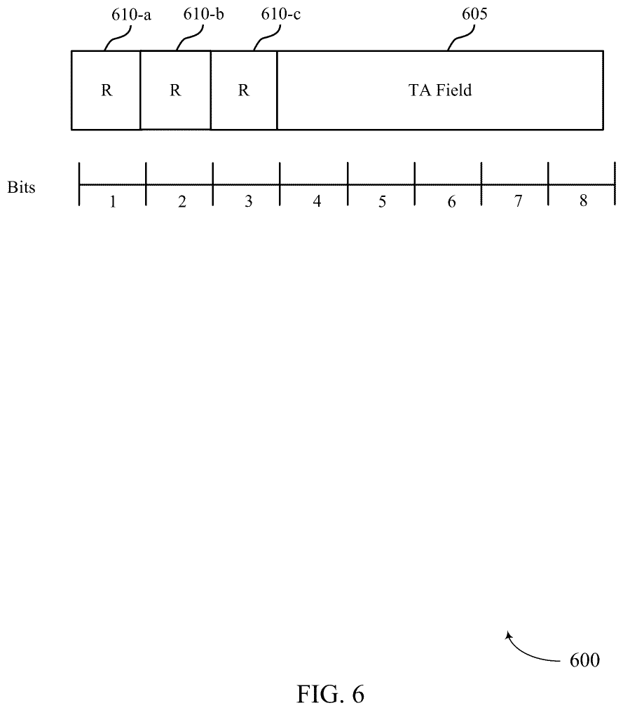

FIG. 6 shows an example of a TA reporting scheme 600 that supports TA reporting formats based on cell type in accordance with one or more aspects of the present disclosure. TA reporting scheme 600 may implement, or be implemented by, aspects of the wireless communications system 100, the wireless communications system 200, the TA reporting scheme 300, the TA reporting scheme 400, or the TA reporting scheme 500. For example, a UE (e.g., such as the UE 115-a) and one or more network entities (e.g., network entities 105, such as the network entity 105-a and the network entity 105-b), which may be examples of corresponding devices described with reference to FIGS. 1-5, may communicate with each other according to the TA reporting scheme 600.

In some examples, the UE may transmit a TA report that is smaller for some types of cells, and larger for other types of cells. For example, for an ATG cell, the UE may use one or more bits (e.g., 5 bits) to indicate the TA value. The TA report may include one or more reserved bits 610 (e.g., the reserved bit 610-a and the reserved bit 610-b, and the reserved bit 610-c). Such a TA report may include a fixed size of a MAC-CE (e.g., 1 octet). The TA report may include one or more reserved bits 610 (e.g., set to 0).

In some examples, the format of the TA report (e.g., a single octet including the one or more bits indicating the TA value and the one or more (e.g., 3) reserved bits) may be reserved for specific cell types (e.g., for ATG cells). In some examples, a reserved LCID code point (e.g., separate from the octets) may be used to indicate the format of the TA report.

In a first type of cell (e.g., an NTN cell) and in some frequency bands (e.g., FR 1), the TA field 605 may indicate the least integer quantity of slots, using a SCS (e.g., of 15 kHz) greater than or equal to the TA value. The length of the TA field 605 may be large (e.g., 14 bits). In some frequency bands (e.g., FR 1), for a second type of cell (e.g., an ATG cell), the TA field 605 may indicate the least integer quantity of symbols greater than or equal to the TA value. The symbol duration may be based on the SCS with which the UE is currently configured (e.g., which may be 15 kHz, or 30 kHz, in some examples). The length of the TA field for the second type of cell (e.g., for symbol-level TA values) may be small (e.g., 5 bits).

In some examples, the UE may include, in the TA report, an indication of the SCS spacing used to determine the symbol duration. For example, one or more of the reserved bits 610, or one or more additional bits (e.g., or a code point of the TA report or the reserved bits 610) may indicate which SCS was used to determine the symbol duration, for the quantity of symbols indicated by the TA field 605. For instance, one of the reserved bits 610 may be utilized to indicate an SCS (e.g., 15 kHz, or 30 kHz).

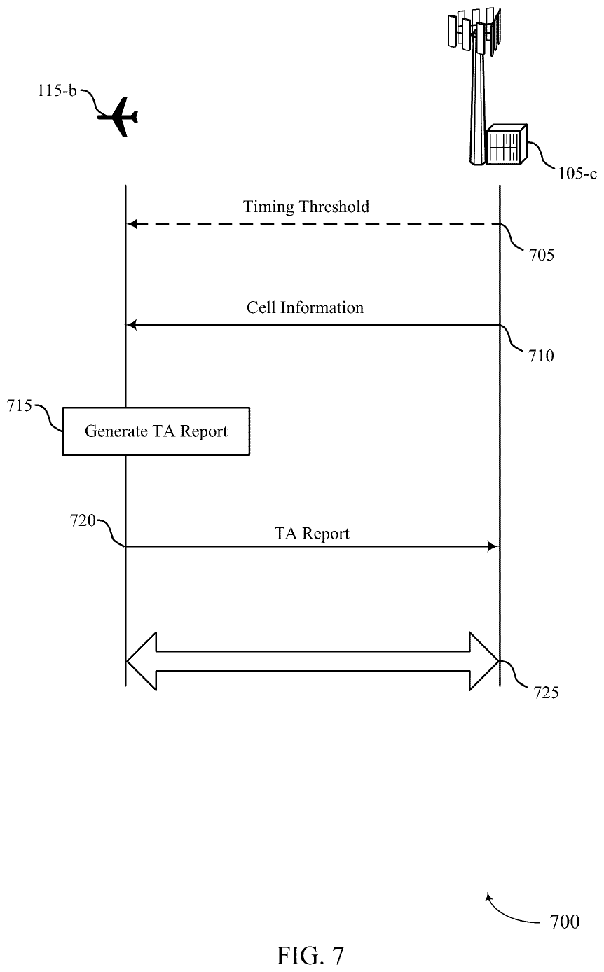

FIG. 7 shows an example of a process flow 700 that supports TA reporting formats based on cell type in accordance with one or more aspects of the present disclosure. The process flow 700 may implement, or be implemented by, aspects of aspects of the wireless communications system 100, the wireless communications system 200, the TA reporting scheme 300, the TA reporting scheme 400, the TA reporting scheme 500, or the TA reporting scheme 600. For example, the process flow may include one or more network entity 105-c, and the UE 115-b, which may be examples of corresponding devices described with reference to FIGS. 1-6.

In some examples, at 705, the UE 115-b may receive (e.g., from a network entity 105, such as the network entity 105-c) a threshold timing offset for a cell type (e.g., for an ATG cell). The threshold timing offset (e.g., a threshold value) may be an information element (IE) in control signaling (e.g., RRC signaling). In some examples, the UE 115-b may receive configuration signaling (e.g., timing advance reporting configuration signaling, such as a TAR-Config IE, which may include a TAR-Config-r17 or TAR-Config-r18 IE).

In some examples, the threshold timing offset may indicate a timing offset experienced by the UE 115-b, that triggers generation and transmission of the TA report. In some examples, the UE 115-b may generate a TA report (e.g., at 715) and transmit the TA report (e.g., at 720) based on receiving the threshold timing offset at 705 (e.g., based on determining that a timing offset satisfies the timing threshold).

The threshold timing offset may be provided (e.g., via the control signaling at 705) in terms of a quantity of symbols (e.g., with a range of 1 symbol to 14 symbols, with spare values). For example, a TAR-Config IE may include the following information:

| | |
|---|---|
| TAR-Config-r18 ::= | SEQUENCE { |
| offsetThresholdTA-r18 | ENUMERATED {1sym, 2sym, 3sym, |
| | 4sym, 5sym, |

6sym, 7sym , 8sym, 9sym, 10sym, 11sym, 12sym, 13sym,

| | |
|---|---|
| 14sym,spare2, spare1} | OPTIONAL, -- Need R |
| timingAdvanceSR-r18 | ENUMERATED {enabled} |
| OPTIONAL, -- Need R | |

In some examples, the threshold timing offset may be provided (e.g., via the control signaling 705 (in terms of a unit of time such as a sampling time unit Tₛ (e.g., with a 16 bit integer value). In such examples, a TAR-Config IE may include the following information:

| | |
|---|---|
| TAR-Config-r18 ::= | SEQUENCE { |
| offsetThresholdTA-r18 | ENUMERATED {1sym, 2sym, 3sym, |
| | 4sym, 5sym, |

6sym, 7sym , 8sym, 9sym, 10sym, 11sym, 12sym, 13sym,

| | |
|---|---|
| 14sym,spare2, spare1} | OPTIONAL, -- Need R |
| timingAdvanceSR-r18 | ENUMERATED {enabled} |
| OPTIONAL, -- Need R | |

At 710, the UE 115-b may receive information indicative that a cell corresponding to the network entity 105-c is a particular type of cell (e.g., an ATG cell). The information may include explicit signaling (e.g., discovery information for a cell, neighbor cell lists, cell identifiers, etc.). In some examples, the UE 115-b may derive the presence of an ATG cell (e.g., based on signaling, resources utilized, one or more rule or conditions, among other examples).

At 715, the UE 115-b may generate, based on the information received or identified at 710 (e.g., based on determining that the cell served by the network entity 105-c is an ATG cell), a TA report. The TA report may be generated in accordance with a format that corresponds to ATG communications (e.g., is specific to an ATG cell).

In some examples, as described in greater detail with reference to FIG. 3, generating the TA report may include generating a TA value indicated by two octets of bits in the TA report. Each code point of the two octets of the TA report may correspond to a respective sampling time unit (e.g., Tₛ) of multiple candidate sampling time units. In such examples, 16 bits of the TA report (e.g., two octets) may be utilized to indicate a TA value that is exact or is closer to an exact TA value (e.g., instead of rounding up to a next integer value quantity of symbols or slots). This may result in increased granularity of TA reporting, and improved accuracy of TA reporting. In some examples, a reserved LCID code point may indicate that the format corresponds to the granularity of sampling time units (e.g., instead of symbols or slots). In some examples, the UE 115-b may receive (e.g., from the network entity 105-c via the cell information at 710, or via other control signaling) an indication that the network entity 105-c supports such a format for the TA report, and may transmit the TA report according to the supported TA report format based thereon.

In some examples, as described in greater detail with reference to FIG. 4, generating the TA report may include generating a TA value indicated by a first subset of bits of the bits of the TA report. Each code point of the first subset of bits (e.g., 5 bits) may correspond to a respective quantity of symbols (e.g., 1 symbol to 28 symbols). In such examples, a second portion of the bits (e.g. 9 bits) may be ignored (e.g., may be null bits). In some examples, a symbol duration corresponding to the TA value may be based on the SCS that the UE 115-b is configured with during generation of the TA value (e.g., the TA report indicates a quantity of symbols, each symbol having a symbol duration based on a currently configured SCS for the UE 115-b).

In some examples, as described in greater detail with reference to FIG. 5, generating the TA report may include setting a first bit of the TA report to indicate the format of the TA report (e.g., indicating a fixed 1 MAC-CE size of 1 byte for an ATG cell). The UE 115-b may generate the TA value indicated by a subset of bits of the TA report (e.g., 5 bits), and may set one or more reserved bits to zero. In some examples, the one or more reserved bits, the first bit indicating the format, and the TA value, may be included in a single octet of the TA report. In some examples, a symbol duration corresponding to the TA value may be based on the SCS that the UE 115-b is configured with during generation of the TA value (e.g., the TA report indicates a quantity of symbols, each symbol having a symbol duration based on a currently configured SCS for the UE 115-b).

In some examples, as described in greater detail with reference to FIG. 6, generating the TA report may include setting one or more reserved bits (e.g., 3 bits) to zero, and generating a TA value indicated by a subset of the bits of the TA report (e.g., 5 bits), each code point indicating a respective quantity of symbols. In some examples, the one or more reserved bits, and the subset of bits indicating the TA value may be a single octet of the TA report. In some examples, the one or more reserved bits, one or more bits indicating the SCS, and the subset of bits indicating the TA value, may be included in a single octet of the TA report. In some examples, a symbol duration corresponding to the TA value may be based on the SCS that the UE 115-b is configured with during generation of the TA value, or the SCS that the UE 115-b indicates in the TA report (e.g., the TA report indicates a quantity of symbols, each symbol having a symbol duration based on a currently configured SCS or the SCS reported in the TA report).

AT 720, the UE 115-b may transmit the TA report (e.g., to the network entity 105-c). At 725, the network entity 105-c may communicate with the UE 115-b based on the received TA report (e.g., may compensate for timing according to the TA value reported in the TA report).

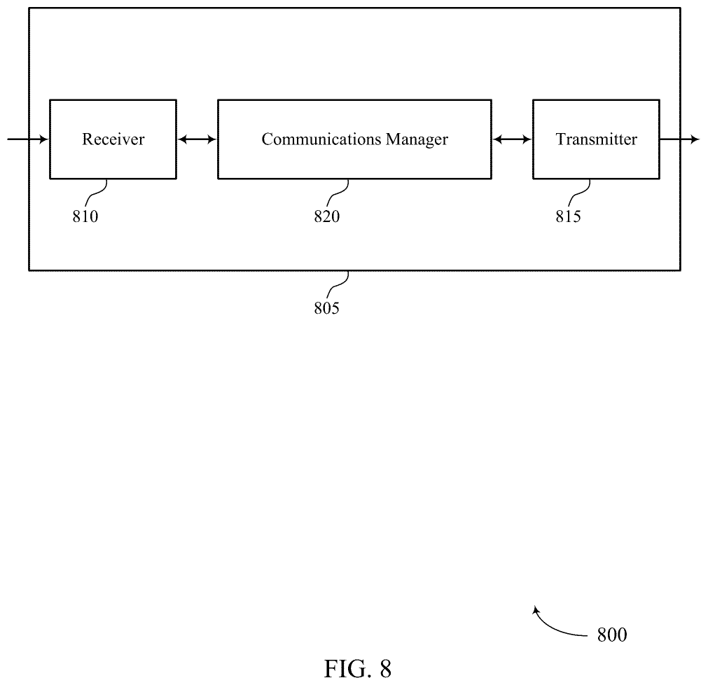

FIG. 8 shows a block diagram 800 of a device 805 that supports TA reporting formats based on cell type in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to TA reporting formats based on cell type). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to TA reporting formats based on cell type). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of TA reporting formats based on cell type as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving information indicative that a cell corresponding to a network entity is an ATG cell. The communications manager 820 is capable of, configured to, or operable to support a means for generating, based on the information, a TA report in accordance with a format that corresponds to ATG communications. The communications manager 820 is capable of, configured to, or operable to support a means for transmitting the TA report in accordance with the format.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for TA reporting resulting in more efficient utilization of system resources, increased throughput, increased reliability of communications, and decreased system latency.

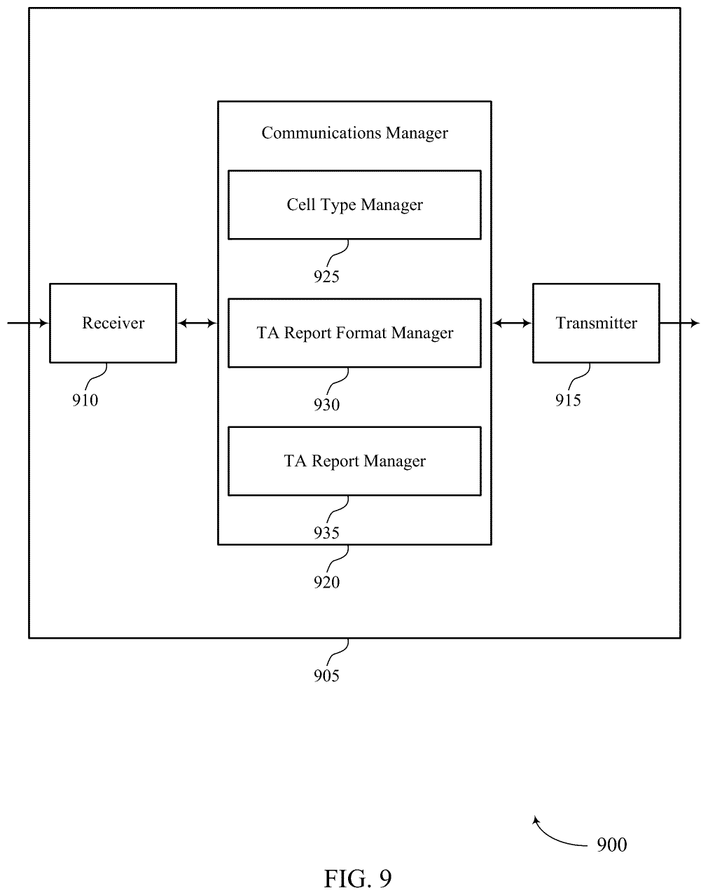

FIG. 9 shows a block diagram 900 of a device 905 that supports TA reporting formats based on cell type in accordance with one or more aspects of the present disclosure. The device 905 may be an example of aspects of a device 805 or a UE 115 as described herein. The device 905 may include a receiver 910, a transmitter 915, and a communications manager 920. The device 905, or one of more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to TA reporting formats based on cell type). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to TA reporting formats based on cell type). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of TA reporting formats based on cell type as described herein. For example, the communications manager 920 may include a cell type manager 925, a TA report format manager 930, a TA report manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The cell type manager 925 is capable of, configured to, or operable to support a means for receiving information indicative that a cell corresponding to a network entity is an ATG cell. The TA report format manager 930 is capable of, configured to, or operable to support a means for generating, based on the information, a TA report in accordance with a format that corresponds to ATG communications. The TA report manager 935 is capable of, configured to, or operable to support a means for transmitting the TA report in accordance with the format.

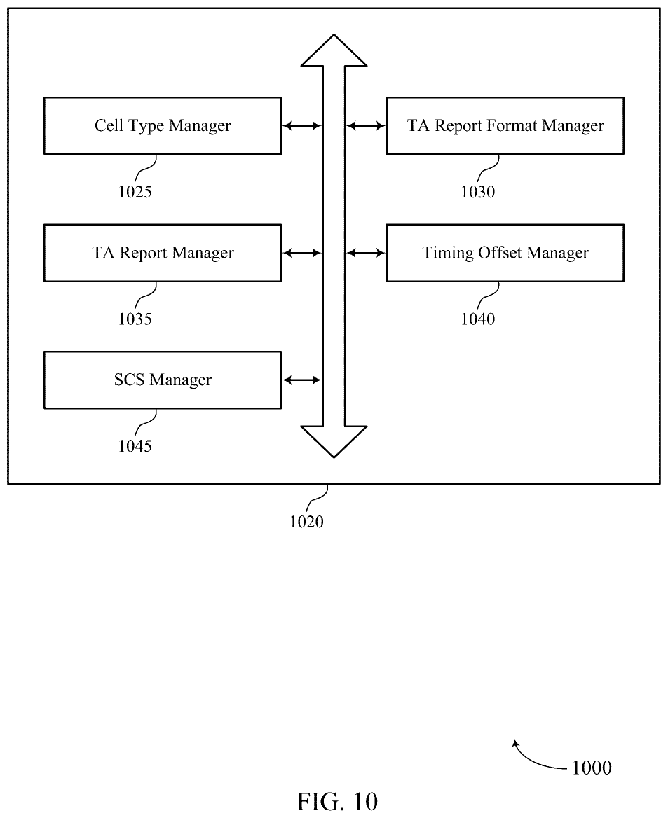

FIG. 10 shows a block diagram 1000 of a communications manager 1020 that supports TA reporting formats based on cell type in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of TA reporting formats based on cell type as described herein. For example, the communications manager 1020 may include a cell type manager 1025, a TA report format manager 1030, a TA report manager 1035, a timing offset manager 1040, an SCS manager 1045, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The cell type manager 1025 is capable of, configured to, or operable to support a means for receiving information indicative that a cell corresponding to a network entity is an ATG cell. The TA report format manager 1030 is capable of, configured to, or operable to support a means for generating, based on the information, a TA report in accordance with a format that corresponds to ATG communications. The TA report manager 1035 is capable of, configured to, or operable to support a means for transmitting the TA report in accordance with the format.

In some examples, to support generating the TA report, the TA report format manager 1030 is capable of, configured to, or operable to support a means for generating a TA value indicated by two octets of bits in the TA report, each code point of the two octets of the TA report corresponding to a respective sampling time unit of a set of multiple candidate sampling time units.

In some examples, a reserved logical channel identity code point includes an indication that the format corresponds to a granularity of sampling time units.

In some examples, to support receiving the information, the cell type manager 1025 is capable of, configured to, or operable to support a means for receiving an indication that the cell supports the format corresponding to the ATG cell.

In some examples, to support generating the TA report, the TA report format manager 1030 is capable of, configured to, or operable to support a means for generating a TA value indicated by a first subset of bits of a set of multiple bits of the TA report, each code point of the first subset of bits corresponding to a respective quantity of symbols, where a second portion of bits of the set of multiple bits are null bits.

In some examples, a symbol duration corresponding to the TA value is based on a subcarrier spacing that the UE is configured with during generation of the TA value.

In some examples, to support generating the TA report, the TA report format manager 1030 is capable of, configured to, or operable to support a means for setting a first bit of a set of multiple bits of the TA report to indicate the format corresponding to the TA report. In some examples, to support generating the TA report, the TA report format manager 1030 is capable of, configured to, or operable to support a means for generating a TA value indicated by a subset of bits of the set of multiple bits of the TA report, each code point of the subset of bits indicating a respective quantity of symbols. In some examples, to support generating the TA report, the TA report format manager 1030 is capable of, configured to, or operable to support a means for setting one or more reserved bits to zero.

In some examples, the one or more reserved bits, the first bit, and the subset of bits, include a single octet of the TA report. In some examples, a symbol duration corresponding to the TA value is based on a subcarrier spacing that the UE is configured with during generation of the TA value.

In some examples, to support generating the TA report, the TA report format manager 1030 is capable of, configured to, or operable to support a means for generating a TA value indicated by a subset of bits of a set of multiple bits of the TA report, each code point of the subset of bits indicating a respective quantity of symbols. In some examples, to support generating the TA report, the TA report format manager 1030 is capable of, configured to, or operable to support a means for setting one or more reserved bits to zero.

In some examples, the one or more reserved bits, and the subset of bits, include a single octet of the TA report. In some examples, a symbol duration corresponding to the TA value is based on a subcarrier spacing that the UE is configured with during generation of the TA value.

In some examples, the one or more reserved bits, one or more bits indicating a subcarrier spacing, and the subset of bits, include a single octet of the TA report. In some examples, a symbol duration corresponding to the TA value is based on the subcarrier spacing during generation of the TA value.

In some examples, the timing offset manager 1040 is capable of, configured to, or operable to support a means for receiving control signaling indicating a threshold timing offset triggering transmission of the TA report, where transmitting the TA report is based on determining that a transmission timing value satisfies the threshold timing offset.

In some examples, the threshold timing offset includes a quantity of symbols, or a quantity of sampling time units.

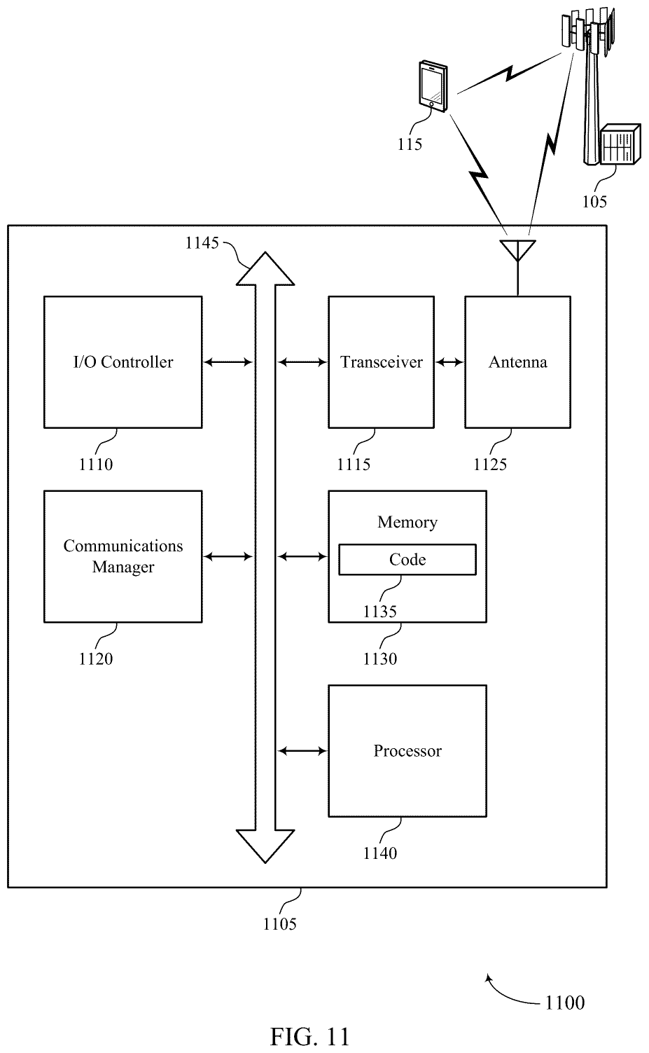

FIG. 11 shows a diagram of a system 1100 including a device 1105 that supports TA reporting formats based on cell type in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable code 1135 including instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may contain, among other things, a basic I/O system (BIOS) which may control basic hardware or software operation such as the interaction with peripheral components or devices.

The at least one processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting TA reporting formats based on cell type). For example, the device 1105 or a component of the device 1105 may include at least one processor 1140 and at least one memory 1130 coupled with or to the at least one processor 1140, the at least one processor 1140 and at least one memory 1130 configured to perform various functions described herein. In some examples, the at least one processor 1140 may include multiple processors and the at least one memory 1130 may include multiple memories. One or more of the multiple processors may be coupled with one or more of the multiple memories, which may, individually or collectively, be configured to perform various functions herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. As such, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving information indicative that a cell corresponding to a network entity is an ATG cell. The communications manager 1120 is capable of, configured to, or operable to support a means for generating, based on the information, a TA report in accordance with a format that corresponds to ATG communications. The communications manager 1120 is capable of, configured to, or operable to support a means for transmitting the TA report in accordance with the format.

By including or configuring the communications manager 1120 in accordance with examples as described herein, the device 1105 may support techniques for TA reporting resulting in more efficient utilization of system resources, increased throughput, increased reliability of communications, improved coordination and timing between devices, more efficient use of computational resources, and decreased system latency.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of TA reporting formats based on cell type as described herein, or the at least one processor 1140 and the at least one memory 1130 may be otherwise configured to, individually or collectively, perform or support such operations.

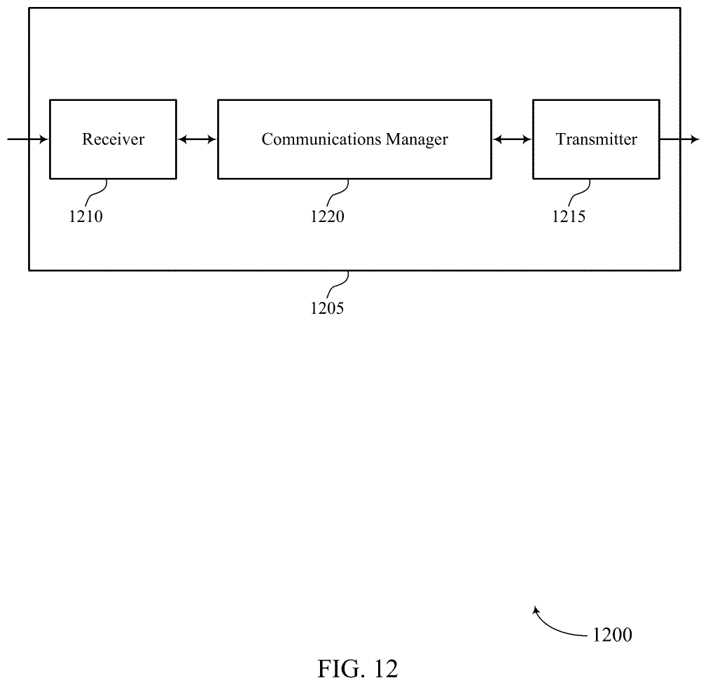

FIG. 12 shows a block diagram 1200 of a device 1205 that supports TA reporting formats based on cell type in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of TA reporting formats based on cell type as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor. If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for transmitting information indicative that a cell corresponding to the network entity is an ATG cell. The communications manager 1220 is capable of, configured to, or operable to support a means for receiving, from a UE and responsive to transmission of the information, a TA report in accordance with a format that corresponds to ATG communications. The communications manager 1220 is capable of, configured to, or operable to support a means for communicating with the UE in accordance with the TA report.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for TA reporting resulting in more efficient utilization of system resources, increased throughput, increased reliability of communications, and decreased system latency.

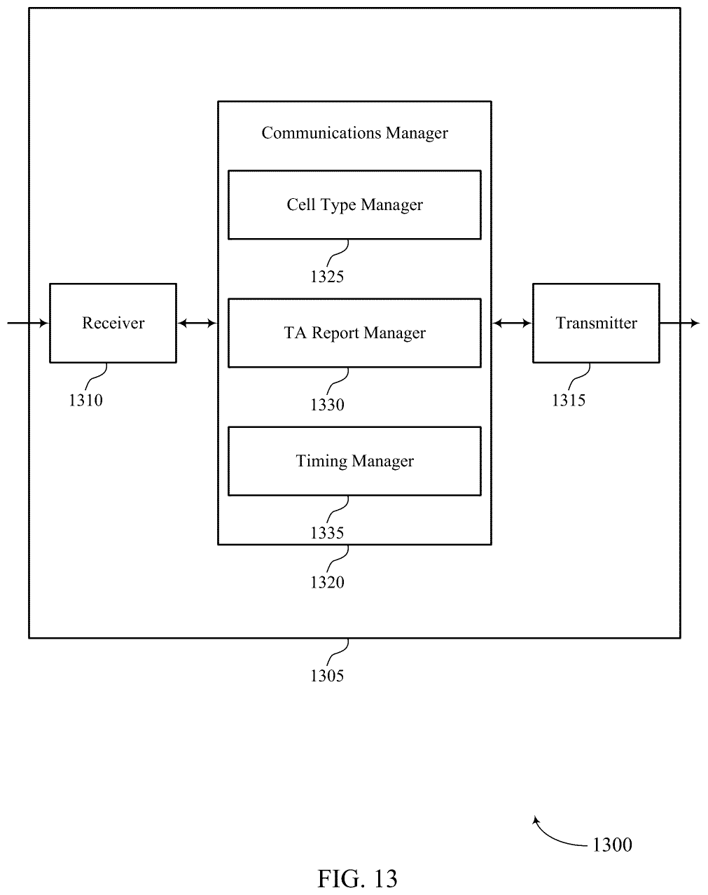

FIG. 13 shows a block diagram 1300 of a device 1305 that supports TA reporting formats based on cell type in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one of more components of the device 1305 (e.g., the receiver 1310, the transmitter 1315, and the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of TA reporting formats based on cell type as described herein. For example, the communications manager 1320 may include a cell type manager 1325, a TA report manager 1330, a timing manager 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The cell type manager 1325 is capable of, configured to, or operable to support a means for transmitting information indicative that a cell corresponding to the network entity is an ATG cell. The TA report manager 1330 is capable of, configured to, or operable to support a means for receiving, from a UE and responsive to transmission of the information, a TA report in accordance with a format that corresponds to ATG communications. The timing manager 1335 is capable of, configured to, or operable to support a means for communicating with the UE in accordance with the TA report.

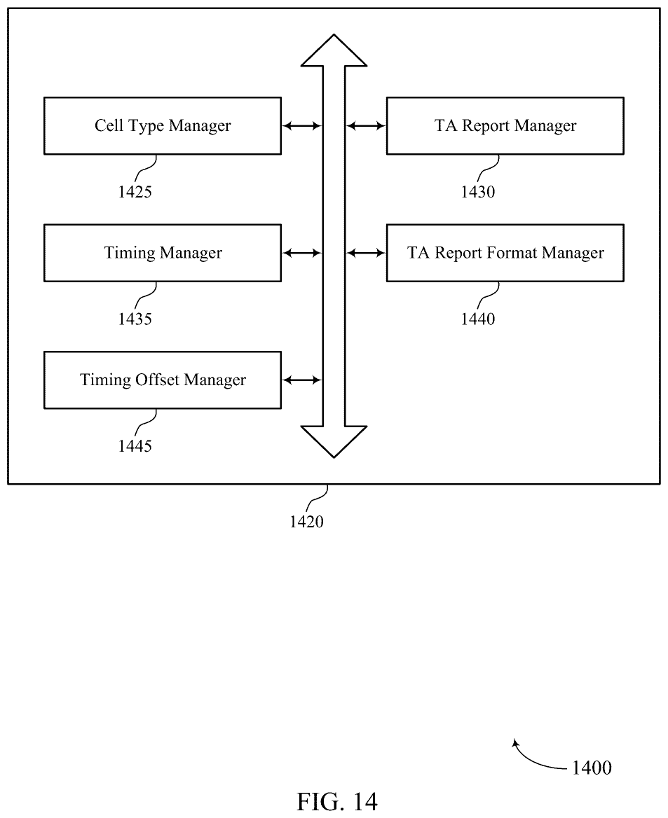

FIG. 14 shows a block diagram 1400 of a communications manager 1420 that supports TA reporting formats based on cell type in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of TA reporting formats based on cell type as described herein. For example, the communications manager 1420 may include a cell type manager 1425, a TA report manager 1430, a timing manager 1435, a TA report format manager 1440, a timing offset manager 1445, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications in accordance with examples as disclosed herein. The cell type manager 1425 is capable of, configured to, or operable to support a means for transmitting information indicative that a cell corresponding to the network entity is an ATG cell. The TA report manager 1430 is capable of, configured to, or operable to support a means for receiving, from a UE and responsive to transmission of the information, a TA report in accordance with a format that corresponds to ATG communications. The timing manager 1435 is capable of, configured to, or operable to support a means for communicating with the UE in accordance with the TA report.

In some examples, to support TA report, the TA report format manager 1440 is capable of, configured to, or operable to support a means for a TA value indicated by two octets of bits in the TA report, each code point of the two octets of the TA report corresponding to a respective sampling time unit of a set of multiple candidate sampling time units.

In some examples, a reserved LCID code point includes an indication that the format corresponds to a granularity of sampling time units.

In some examples, to support transmitting the information, the cell type manager 1425 is capable of, configured to, or operable to support a means for transmitting an indication that the cell supports the format corresponding to the ATG cell.

In some examples, to support TA report, the TA report format manager 1440 is capable of, configured to, or operable to support a means for a TA value indicated by a first subset of bits of a set of multiple bits of the TA report, each code point of the first subset of bits corresponding to a respective quantity of symbols, where a second portion of bits of the set of multiple bits are null bits.

In some examples, a symbol duration corresponding to the TA value is based on a subcarrier spacing with which the UE is configured.

In some examples, to support TA report, the TA report format manager 1440 is capable of, configured to, or operable to support a means for a first bit of a set of multiple bits indicating the format corresponding to the TA report, a TA value indicated by a subset of bits of the set of multiple bits of the TA report, each code point of the subset of bits indicating a respective quantity of symbols, and one or more reserved bits.

In some examples, the one or more reserved bits, the first bit, and the subset of bits, include a single octet of the TA report, and a symbol duration corresponding to the TA value is based on a subcarrier spacing with which the UE is configured.

In some examples, to support TA report, the TA report format manager 1440 is capable of, configured to, or operable to support a means for a TA value indicated by a subset of bits of a set of multiple bits of the TA report, each code point of the subset of bits indicating a respective quantity of symbols, and one or more reserved bits.

In some examples, the one or more reserved bits, and the subset of bits, include a single octet of the TA report, and a symbol duration corresponding to the TA value is based on a subcarrier spacing with which the UE is configured.

In some examples, the one or more reserved bits, one or more bits indicating a subcarrier spacing, and the subset of bits, include a single octet of the TA report, a symbol duration corresponding to the TA value is based on a subcarrier spacing with which the UE is configured.

In some examples, the timing offset manager 1445 is capable of, configured to, or operable to support a means for transmitting control signaling indicating a threshold timing offset triggering transmission of the TA report, where receiving the TA report is based on a transmission timing value satisfying the threshold timing offset.

In some examples, the threshold timing offset includes a quantity of symbols, or a quantity of sampling time units.

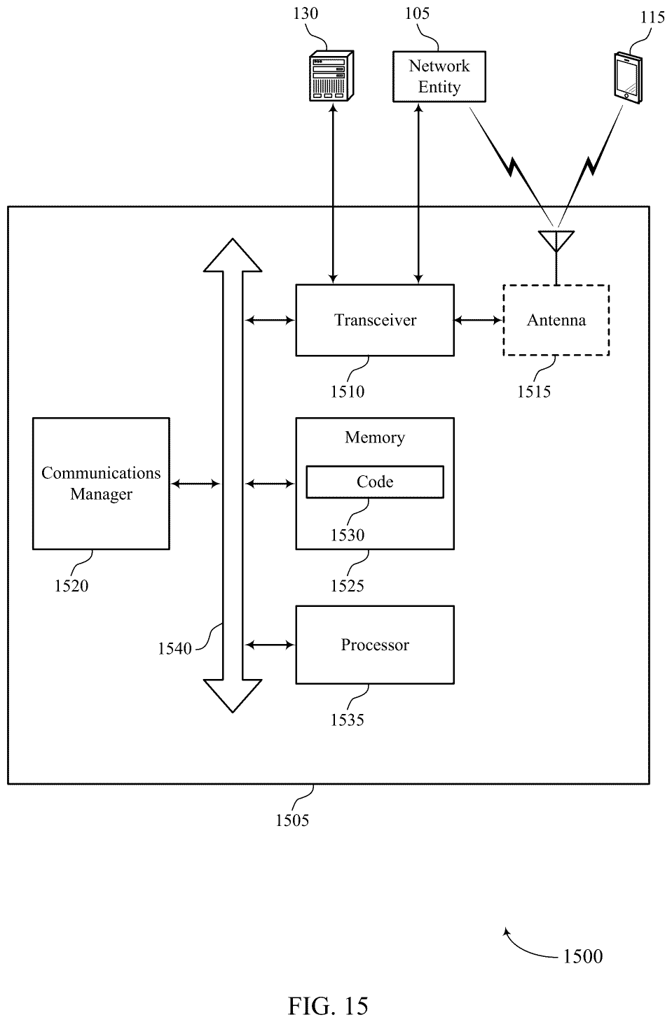

FIG. 15 shows a diagram of a system 1500 including a device 1505 that supports TA reporting formats based on cell type in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., a communication link 125, a backhaul communication link 120, a midhaul communication link 162, a fronthaul communication link 168).

The at least one memory 1525 may include RAM, ROM, or any combination thereof. The at least one memory 1525 may store computer-readable, computer-executable code 1530 including instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may contain, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting TA reporting formats based on cell type). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525). In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. As such, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communications in accordance with examples as disclosed herein. For example, the communications manager 1520 is capable of, configured to, or operable to support a means for transmitting information indicative that a cell corresponding to the network entity is an ATG cell. The communications manager 1520 is capable of, configured to, or operable to support a means for receiving, from a UE and responsive to transmission of the information, a TA report in accordance with a format that corresponds to ATG communications. The communications manager 1520 is capable of, configured to, or operable to support a means for communicating with the UE in accordance with the TA report.

By including or configuring the communications manager 1520 in accordance with examples as described herein, the device 1505 may support techniques for TA reporting resulting in more efficient utilization of system resources, increased throughput, increased reliability of communications, improved coordination and timing between devices, more efficient use of computational resources, and decreased system latency.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of TA reporting formats based on cell type as described herein, or the at least one processor 1535 and the at least one memory 1525 may be otherwise configured to, individually or collectively, perform or support such operations.

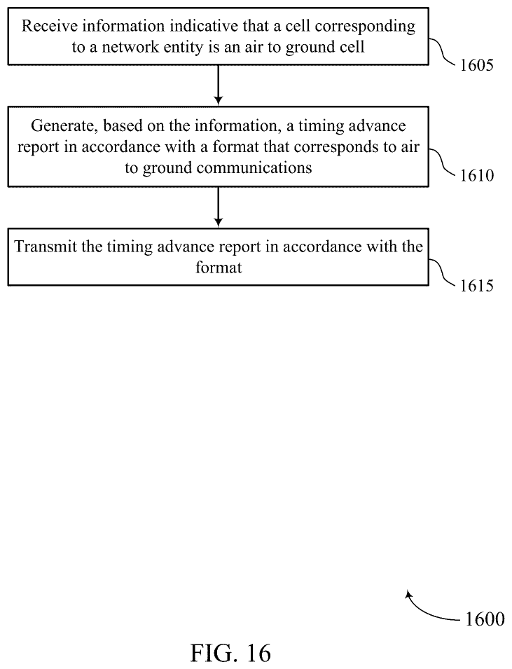

FIG. 16 shows a flowchart illustrating a method 1600 that supports TA reporting formats based on cell type in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving information indicative that a cell corresponding to a network entity is an ATG cell. The operations of block 1605 may be performed in accordance with examples as disclosed herein. In some examples, aspects of the operations of 1605 may be performed by a cell type manager 1025 as described with reference to FIG. 10.

At 1610, the method may include generating, based on the information, a TA report in accordance with a format that corresponds to ATG communications. The operations of block 1610 may be performed in accordance with examples as disclosed herein. In some examples, aspects of the operations of 1610 may be performed by a TA report format manager 1030 as described with reference to FIG. 10.

At 1615, the method may include transmitting the TA report in accordance with the format. The operations of block 1615 may be performed in accordance with examples as disclosed herein. In some examples, aspects of the operations of 1615 may be performed by a TA report manager 1035 as described with reference to FIG. 10.

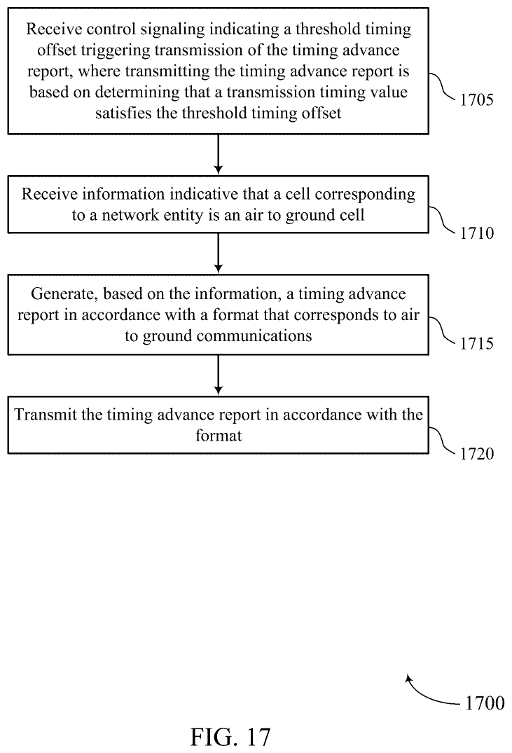

FIG. 17 shows a flowchart illustrating a method 1700 that supports TA reporting formats based on cell type in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving control signaling indicating a threshold timing offset triggering transmission of the TA report, where transmitting the TA report is based on determining that a transmission timing value satisfies the threshold timing offset. The operations of block 1705 may be performed in accordance with examples as disclosed herein. In some examples, aspects of the operations of 1705 may be performed by a timing offset manager 1040 as described with reference to FIG. 10.

At 1710, the method may include receiving information indicative that a cell corresponding to a network entity is an ATG cell. The operations of block 1710 may be performed in accordance with examples as disclosed herein. In some examples, aspects of the operations of 1710 may be performed by a cell type manager 1025 as described with reference to FIG. 10.

At 1715, the method may include generating, based on the information, a TA report in accordance with a format that corresponds to ATG communications. The operations of block 1715 may be performed in accordance with examples as disclosed herein. In some examples, aspects of the operations of 1715 may be performed by a TA report format manager 1030 as described with reference to FIG. 10.

At 1720, the method may include transmitting the TA report in accordance with the format. The operations of block 1720 may be performed in accordance with examples as disclosed herein. In some examples, aspects of the operations of 1720 may be performed by a TA report manager 1035 as described with reference to FIG. 10.

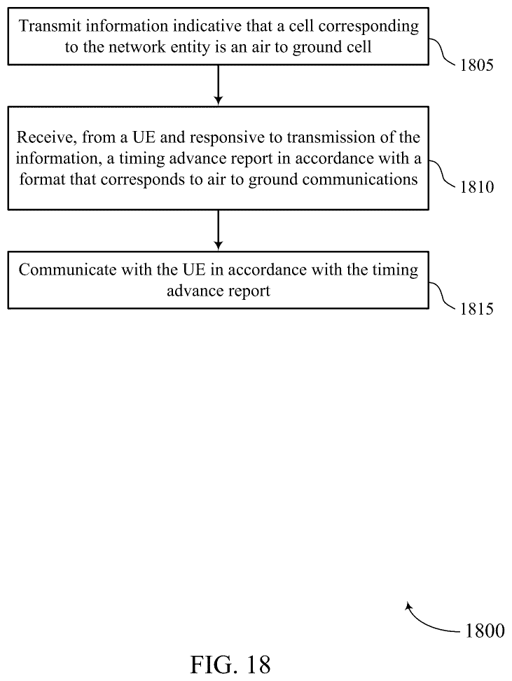

FIG. 18 shows a flowchart illustrating a method 1800 that supports TA reporting formats based on cell type in accordance with aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1805, the method may include transmitting information indicative that a cell corresponding to the network entity is an ATG cell. The operations of block 1805 may be performed in accordance with examples as disclosed herein. In some examples, aspects of the operations of 1805 may be performed by a cell type manager 1425 as described with reference to FIG. 14.

At 1810, the method may include receiving, from a UE and responsive to transmission of the information, a TA report in accordance with a format that corresponds to ATG communications. The operations of block 1810 may be performed in accordance with examples as disclosed herein. In some examples, aspects of the operations of 1810 may be performed by a TA report manager 1430 as described with reference to FIG. 14.

At 1815, the method may include communicating with the UE in accordance with the TA report. The operations of block 1815 may be performed in accordance with examples as disclosed herein. In some examples, aspects of the operations of 1815 may be performed by a timing manager 1435 as described with reference to FIG. 14.

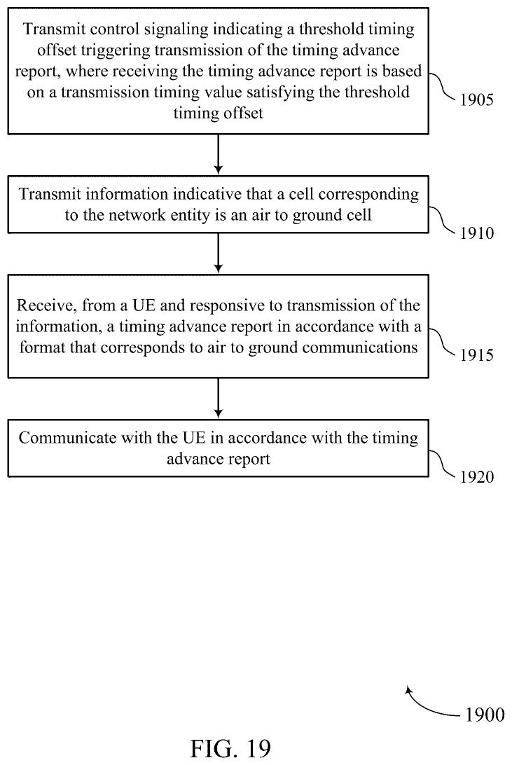

FIG. 19 shows a flowchart illustrating a method 1900 that supports TA reporting formats based on cell type in accordance with aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include transmitting control signaling indicating a threshold timing offset triggering transmission of the TA report, where receiving the TA report is based on a transmission timing value satisfying the threshold timing offset. The operations of block 1905 may be performed in accordance with examples as disclosed herein. In some examples, aspects of the operations of 1905 may be performed by a timing offset manager 1445 as described with reference to FIG. 14.

At 1910, the method may include transmitting information indicative that a cell corresponding to the network entity is an ATG cell. The operations of block 1910 may be performed in accordance with examples as disclosed herein. In some examples, aspects of the operations of 1910 may be performed by a cell type manager 1425 as described with reference to FIG. 14.

At 1915, the method may include receiving, from a UE and responsive to transmission of the information, a TA report in accordance with a format that corresponds to ATG communications. The operations of block 1915 may be performed in accordance with examples as disclosed herein. In some examples, aspects of the operations of 1915 may be performed by a TA report manager 1430 as described with reference to FIG. 14.

At 1920, the method may include communicating with the UE in accordance with the TA report. The operations of block 1920 may be performed in accordance with examples as disclosed herein. In some examples, aspects of the operations of 1920 may be performed by a timing manager 1435 as described with reference to FIG. 14.

The following provides an overview of aspects of the present disclosure:

Aspect 1: A method for wireless communications at a UE, comprising: receiving information indicative that a cell corresponding to a network entity is an ATG cell; generating, based at least in part on the information, a TA report in accordance with a format that corresponds to ATG communications; and transmitting the TA report in accordance with the format.

Aspect 2: The method of aspect 1, wherein generating the TA report comprises: generating a TA value indicated by two octets of bits in the TA report, each codepoint of the two octets of the TA report corresponding to a respective sampling time unit of a plurality of candidate sampling time units.

Aspect 3: The method of aspect 2, wherein a reserved logical channel identity code point comprises an indication that the format corresponds to a granularity of sampling time units.

Aspect 4: The method of any of aspects 2 through 3, wherein receiving the information comprises: receiving an indication that the cell supports the format corresponding to the ATG cell.

Aspect 5: The method of any of aspects 1 through 4, wherein generating the TA report comprises: generating a TA value indicated by a first subset of bits of a plurality of bits of the TA report, each codepoint of the first subset of bits corresponding to a respective quantity of symbols, wherein a second portion of bits of the plurality of bits are null bits.

Aspect 6: The method of aspect 5, wherein a symbol duration corresponding to the TA value is based at least in part on a subcarrier spacing that the UE is configured with during generation of the TA value.

Aspect 7: The method of any of aspects 1 through 6, wherein generating the TA report comprises: setting a first bit of a plurality of bits of the TA report to indicate the format corresponding to the TA report; generating a TA value indicated by a subset of bits of the plurality of bits of the TA report, each codepoint of the subset of bits indicating a respective quantity of symbols; and setting one or more reserved bits to zero.

Aspect 8: The method of aspect 7, wherein the one or more reserved bits, the first bit, and the subset of bits, comprise a single octet of the TA report, and a symbol duration corresponding to the TA value is based at least in part on a subcarrier spacing that the UE is configured with during generation of the TA value.

Aspect 9: The method of any of aspects 1 through 8, wherein generating the TA report comprises: generating a TA value indicated by a subset of bits of a plurality of bits of the TA report, each codepoint of the subset of bits indicating a respective quantity of symbols; and setting one or more reserved bits to zero.

Aspect 10: The method of aspect 9, wherein the one or more reserved bits, and the subset of bits, comprise a single octet of the TA report, and a symbol duration corresponding to the TA value is based at least in part on a subcarrier spacing that the UE is configured with during generation of the TA value.

Aspect 11: The method of any of aspects 9 through 10, wherein the one or more reserved bits, one or more bits indicating a subcarrier spacing, and the subset of bits, comprise a single octet of the TA report, and a symbol duration corresponding to the TA value is based at least in part on the subcarrier spacing during generation of the TA value.

Aspect 12: The method of any of aspects 1 through 11, further comprising: receiving control signaling indicating a threshold timing offset triggering transmission of the TA report, wherein transmitting the TA report is based at least in part on determining that a transmission timing value satisfies the threshold timing offset.

Aspect 13: The method of aspect 12, wherein the threshold timing offset comprises a quantity of symbols, or a quantity of sampling time units.

Aspect 14: A method for wireless communications at a network entity, comprising: transmitting information indicative that a cell corresponding to the network entity is an ATG cell; receiving, from a UE and responsive to transmission of the information, a TA report in accordance with a format that corresponds to ATG communications; and communicating with the UE in accordance with the TA report.

Aspect 15: The method of aspect 14, wherein the TA report comprises: a TA value indicated by two octets of bits in the TA report, each codepoint of the two octets of the TA report corresponding to a respective sampling time unit of a plurality of candidate sampling time units.

Aspect 16: The method of aspect 15, wherein a reserved logical channel identify code point comprises an indication that the format corresponds to a granularity of sampling time units.

Aspect 17: The method of any of aspects 15 through 16, wherein transmitting the information comprises: transmitting an indication that the cell supports the format corresponding to the ATG cell.

Aspect 18: The method of any of aspects 14 through 17, wherein the TA report comprises: a TA value indicated by a first subset of bits of a plurality of bits of the TA report, each codepoint of the first subset of bits corresponding to a respective quantity of symbols, wherein a second portion of bits of the plurality of bits are null bits.

Aspect 19: The method of aspect 18, wherein a symbol duration corresponding to the TA value is based at least in part on a subcarrier spacing with which the UE is configured.

Aspect 20: The method of any of aspects 14 through 19, wherein the TA report comprises: a first bit of a plurality of bits indicating the format corresponding to the TA report, a TA value indicated by a subset of bits of the plurality of bits of the TA report, each codepoint of the subset of bits indicating a respective quantity of symbols, and one or more reserved bits.

Aspect 21: The method of aspect 20, wherein the one or more reserved bits, the first bit, and the subset of bits, comprise a single octet of the TA report, and a symbol duration corresponding to the TA value is based at least in part on a subcarrier spacing with which the UE is configured.

Aspect 22: The method of any of aspects 14 through 21, wherein the TA report comprises: a TA value indicated by a subset of bits of a plurality of bits of the TA report, each codepoint of the subset of bits indicating a respective quantity of symbols, and one or more reserved bits.

Aspect 23: The method of aspect 22, wherein the one or more reserved bits, and the subset of bits, comprise a single octet of the TA report, and a symbol duration corresponding to the TA value is based at least in part on a subcarrier spacing with which the UE is configured.

Aspect 24: The method of any of aspects 22 through 23, wherein the one or more reserved bits, one or more bits indicating a subcarrier spacing, and the subset of bits, comprise a single octet of the TA report, a symbol duration corresponding to the TA value is based at least in part on a subcarrier spacing with which the UE is configured.

Aspect 25: The method of any of aspects 14 through 24, further comprising: transmitting control signaling indicating a threshold timing offset triggering transmission of the TA report, wherein receiving the TA report is based at least in part on a transmission timing value satisfying the threshold timing offset.

Aspect 26: The method of aspect 25, wherein the threshold timing offset comprises a quantity of symbols, or a quantity of sampling time units.

Aspect 27: A UE for wireless communications, comprising one or more memories storing processor-executable code, and one or more processors coupled with the one or more memories and individually or collectively operable to execute the code to cause the UE to perform a method of any of aspects 1 through 13.

Aspect 28: A UE for wireless communications, comprising at least one means for performing a method of any of aspects 1 through 13.

Aspect 29: A non-transitory computer-readable medium storing code for wireless communications, the code comprising instructions executable by a processor to perform a method of any of aspects 1 through 13.

Aspect 30: A network entity for wireless communications, comprising one or more memories storing processor-executable code, and one or more processors coupled with the one or more memories and individually or collectively operable to execute the code to cause the network entity to perform a method of any of aspects 14 through 26.

Aspect 31: A network entity for wireless communications, comprising at least one means for performing a method of any of aspects 14 through 26.

Aspect 32: A non-transitory computer-readable medium storing code for wireless communications, the code comprising instructions executable by a processor to perform a method of any of aspects 14 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive information indicative that a cell corresponding to a network entity is an air to ground cell;
generate, based at least in part on the information, a timing advance report in accordance with a format that corresponds to air to ground communications; and
transmit the timing advance report in accordance with the format.

2. The UE of claim 1, wherein, to generate the timing advance report, the one or more processors are individually or collectively operable to execute the code to cause the UE to:
generate a timing advance value indicated by a first subset of bits of a plurality of bits of the timing advance report, each code point of the first subset of bits corresponding to a respective quantity of symbols, wherein a second portion of bits of the plurality of bits are null bits.

3. The UE of claim 2, wherein a symbol duration corresponding to the timing advance value is based at least in part on a subcarrier spacing that the UE is configured with during generation of the timing advance value.

4. The UE of claim 2, wherein a symbol duration corresponding to the timing advance value is based at least in part on a subcarrier spacing with which the UE is configured via control signaling.

5. The UE of claim 1, wherein, to generate the timing advance report, the one or more processors are individually or collectively operable to execute the code to cause the UE to:
set a first bit of a plurality of bits of the timing advance report to indicate the format corresponding to the timing advance report;
generate a timing advance value indicated by a subset of bits of the plurality of bits of the timing advance report, each code point of the subset of bits indicating a respective quantity of symbols; and
set one or more remaining bits to zero.

6. The UE of claim 5, wherein:
the one or more remaining bits, the first bit, and the subset of bits, comprise a single octet of the timing advance report, and
a symbol duration corresponding to the timing advance value is based at least in part on a subcarrier spacing that the UE is configured with during generation of the timing advance value.

7. The UE of claim 5, wherein:
a symbol duration corresponding to the timing advance value is based at least in part on a subcarrier spacing with which the UE is configured via control signaling.

8. The UE of claim 1, wherein, to generate the timing advance report, the one or more processors are individually or collectively operable to execute the code to cause the UE to:
generate a timing advance value indicated by two octets of bits in the timing advance report, each code point of the two octets of the timing advance report corresponding to a respective sampling time unit of a plurality of candidate sampling time units.

9. The UE of claim 8, wherein a reserved logical channel identity code point comprises an indication that the format corresponds to a granularity of sampling time units.

10. The UE of claim 8, wherein, to receive the information, the one or more processors are individually or collectively operable to execute the code to cause the UE to:
receive an indication that the cell supports the format corresponding to the air to ground cell.

11. The UE of claim 1, wherein, to generate the timing advance report, the one or more processors are individually or collectively operable to execute the code to cause the UE to:
generate a timing advance value indicated by a subset of bits of a plurality of bits of the timing advance report, each code point of the subset of bits indicating a respective quantity of symbols; and
set one or more reserved bits to zero.

12. The UE of claim 11, wherein:
the one or more reserved bits, and the subset of bits, comprise a single octet of the timing advance report, and
a symbol duration corresponding to the timing advance value is based at least in part on a subcarrier spacing that the UE is configured with during generation of the timing advance value.

13. The UE of claim 1, wherein the one or more processors are individually or collectively further operable to execute the code to cause the UE to:
receive control signaling indicating a threshold timing offset triggering transmission of the timing advance report, wherein transmitting the timing advance report is based at least in part on determining that a transmission timing value satisfies the threshold timing offset.

14. A network entity, comprising:
one or more memories storing processor-executable code; and
one or more processors coupled with the one or more memories and individually or collectively operable to execute the code to cause the network entity to:
transmit information indicative that a cell corresponding to the network entity is an air to ground cell;
receive, from a user equipment (UE) and responsive to transmission of the information, a timing advance report in accordance with a format that corresponds to air to ground communications; and
communicate with the UE in accordance with the timing advance report.

15. The network entity of claim 14, wherein the timing advance report comprises a timing advance value indicated by a first subset of bits of a plurality of bits of the timing advance report, each code point of the first subset of bits corresponding to a respective quantity of symbols, wherein a second portion of bits of the plurality of bits are null bits.

16. The network entity of claim 15, wherein a symbol duration corresponding to the timing advance value is based at least in part on a subcarrier spacing with which the UE is configured.

17. The network entity of claim 14, wherein the timing advance report comprises a first bit of a plurality of bits that indicates the format corresponding to the timing advance report, a timing advance value indicated by a subset of bits of the plurality of bits of the timing advance report, each code point of the subset of bits indicating a respective quantity of symbols, and one or more reserved bits.

18. The network entity of claim 17, wherein the one or more reserved bits, the first bit, and the subset of bits, comprise a single octet of the timing advance report, and a symbol duration corresponding to the timing advance value is based at least in part on a subcarrier spacing with which the UE is configured.

19. The network entity of claim 14, wherein the timing advance report comprises a timing advance value indicated by a subset of bits of a plurality of bits of the timing advance report, each code point of the subset of bits indicating a respective quantity of symbols, and one or more reserved bits.

20. The network entity of claim 19, wherein the one or more reserved bits, and the subset of bits, comprise a single octet of the timing advance report, and a symbol duration corresponding to the timing advance value is based at least in part on a subcarrier spacing with which the UE is configured.
